(19) United States
(12) Patent Application Publication
(10) Pub. No.: US 2007/0086931 A1
(43) Pub. Date: Apr. 19, 2007

(54) Methods and apparatus for process abatement

(75) Inventors: Sebastien Raoux, Santa Clara, CA (US); Brian Kingston, San Jose, CA (US); Mark Curry, Morgan Hill, CA (US); Daniel Clark, Pleasanton, CA (US); Robbert Vermeulen, Pleasant Hill, CA (US); Belynda Flippo, Capitola, CA (US); Mark Holst, Sunnyvale, CA (US); Steve Tsu, Los Gatos, CA (US); Kevin Lin, Taipei City (TW); Monique Mcintosh, San Jose, CA (US)

Correspondence Address: DUGAN & DUGAN, PC, 55 SOUTH BROADWAY, TARRYTOWN, NY, 10591, US

(73) Assignee: Applied Materials, Inc., Santa Clara, CA (US)

(21) Appl. No.: 11/452,188

(22) Filed: Jun. 13, 2006

Related U.S. Application Data
(60) Provisional application No. 60/690,340, filed on Jun. 13, 2005.

(51) Int. Cl. B01D 53/34; B01D 53/46; B01D 53/86

(52) U.S. Cl. 422/168; 422/177; 423/210

(57) ABSTRACT

In a first aspect, a first abatement apparatus is provided. The first abatement apparatus includes (1) an oxidation unit adapted to receive an effluent stream from a semiconductor device manufacturing chamber; (2) a first water scrubber unit adapted to receive the effluent stream from the oxidation unit; and (3) a catalysis unit adapted to receive the effluent stream from the first water scrubber unit. Numerous other aspects are provided.

The present application claims priority from U.S. Provisional Patent Application Ser. No. 60/690,340, filed Jun. 13, 2005 (Attorney Docket No. 10324/L), which is hereby incorporated by reference herein in its entirety.

### FIELD OF THE INVENTION

The present invention relates generally to semiconductor device manufacturing, and more particularly to methods and apparatus for abating semiconductor device manufacturing equipment.

### BACKGROUND OF THE INVENTION

Fluorocarbon, chlorofluorocarbon, hydrocarbon, and other fluorine containing gases are used in, or formed as a byproduct during, the manufacture of active and passive electronic circuitry in process chambers. These gases are toxic to humans and hazardous to the environment. In addition, they may also strongly absorb infrared radiation and have high global warming potentials. Especially notorious are persistent fluorinated compounds or perfluorocompounds (PFCs) which are long-lived, chemically stable compounds that have lifetimes often exceeding thousands of years. Some examples of PFCs are carbon tetrafluoride (CF₄), hexafluoroethane (C₂F₆), perfluorocyclobutane (C₄F₈), difluoromethane (CH₂F₂), perfluorocyclobutene (C₄F₆), perafluoropropane (C₃F₈), trifluoromethane (CHF₃), sulfur hexafluoride (SF₆), nitrogen trifluoride (NF₃), carbonyl fluoride (COF₂) and the like.

Another hazardous gas is molecular fluorine, F₂. Extended exposure to as little as 1 ppm of F₂ can be hazardous, and F₂ is difficult to breakdown or reduce to non-toxic forms. Previously, effluents containing F₂ have been exhausted through exhaust stacks that are sufficiently tall that the concentration of F₂ in the air that descends to the ground is below regulatory levels. However, this technique is less than ideal from an environmental standpoint, and also undesirable from a manufacturing standpoint in that the volume of fluorinated gas processes that generate F₂ is limited by the height of the exhaust stack. Thus, it is desirable to have apparatus and methods that can reduce the hazardous gas content of effluents, especially effluents containing F₂, that may be released from process chambers.

### SUMMARY OF THE INVENTION

In a first aspect of the invention, a first abatement apparatus is provided. The first abatement apparatus includes (1) an oxidation unit adapted to receive an effluent stream from a semiconductor device manufacturing chamber; (2) a first water scrubber unit adapted to receive the effluent stream from the oxidation unit; and (3) a catalysis unit adapted to receive the effluent stream from the first water scrubber unit.

In a second aspect of the invention, a second abatement apparatus is provided. The second abatement apparatus includes (1) an oxidation unit adapted to receive an effluent stream from a semiconductor device manufacturing chamber and to abate the effluent stream; (2) a first water scrubber unit adapted to receive the effluent stream from the oxidation unit and to scrub the effluent stream; (3) a second water scrubber unit adapted to receive the effluent stream from the first water scrubber unit and to scrub the effluent stream; (4) a catalysis unit adapted to receive the effluent stream from the second water scrubber unit and to abate the effluent stream; (5) a third water scrubber unit adapted to receive the effluent stream from the catalysis unit and to scrub the effluent stream; and (6) a fourth water scrubber unit adapted to receive the effluent stream from the third water scrubber unit and to scrub the effluent stream.

In a third aspect of the invention, a method is provided for abating a gaseous waste stream of a semiconductor device manufacturing system. The method includes (1) receiving the gaseous waste stream; (2) abating the gaseous waste stream in an oxidation chamber; (3) scrubbing the gaseous waste stream after abating the gaseous waste stream in the oxidation chamber; (4) abating the gaseous waste stream in a catalyst chamber; and (5) scrubbing the gaseous waste stream after abating the gaseous waste stream in the catalyst chamber.

In a fourth aspect of the invention, a method is provided for forming an abatement system. The method includes (1) providing a first abatement system having an oxidation chamber and at least one scrubber; (2) providing a second abatement system having a catalysis chamber and at least one scrubber; and (3) configuring the first and second abatement systems so as to form a single abatement unit in which a waste stream is abated within the first abatement system and then within the second abatement system. Numerous other aspects are provided.

Other features and aspects of the present invention will become more fully apparent from the following detailed description, the appended claims and the accompanying drawings.

### BRIEF DESCRIPTION OF THE DRAWINGS

FIG. 1 is a schematic diagram of a first exemplary processing system provided in accordance with the present invention.

FIG. 2 is a schematic diagram of a first exemplary embodiment of the abatement system of FIG. 1 in accordance with the present invention.

FIG. 3 is a side perspective view of the abatement system of FIG. 2 in which the catalytic backpack has been moved so as to provide service access to a post oxidation scrubber side of the oxidation system in accordance with the present invention.

FIG. 4 is a schematic diagram of a second exemplary embodiment of the abatement system of FIG. 1 in accordance with the present invention.

FIG. 5 is a schematic diagram of an alternative embodiment of the abatement system of FIG. 4 in accordance with the present invention.

FIG. 6 illustrates a schematic view of a first apparatus for heating a catalyst bed provided in accordance with the present invention.

FIG. 7 illustrates a schematic view of a second apparatus for heating a catalyst bed provided in accordance with the present invention.

FIG. 8 illustrates a schematic view of a third apparatus for heating a catalyst bed provided in accordance with the present invention.

FIG. 9 illustrates a schematic view of a fourth apparatus for heating a catalyst bed provided in accordance with the present invention.

FIG. 10 is a schematic diagram of an exemplary cross heat exchanger that may be used for the heat exchanger of the catalyst backpack and/or for the heat exchanger of the oxidation system of FIGS. 4-5 in accordance with the present invention.

### DETAILED DESCRIPTION

The present invention provides methods and apparatus for abating semiconductor device manufacturing equipment. For example, the present invention may be employed to abate perfluorocompounds (PFCs), hazardous air pollutants (HAPs), volatile organic compounds (VOCs) or other similar materials generated during semiconductor device manufacturing processes and/or during cleaning of semiconductor device manufacturing equipment such as processes and/or chambers associated with plasma enhanced chemical vapor deposition (PECVD), low K or high K deposition, high density plasma CVD (HDPCVD), sub-atmospheric CVD (SACVD), low pressure CVD (LPCVD), metal CVD (MCVD), etch, epitaxial growth, rapid thermal processing (RTP), implant, etc. In one exemplary embodiment, the present invention may be employed to abate PFCs generated during the cleaning of a CVD chamber.

In one or more embodiments of the invention, abatement is improved by combining electric oxidation, thermal catalysis and water scrubbing technologies. Such a combination may provide 99% abatement efficiency on nearly all semiconductor gaseous byproducts including PFCs, HAPs and VOCs.

Embodiments of the invention may be retrofitted to existing products, such as the controlled decomposition and oxidation (CDO) system available from the Ecosys division of Metron Technology of San Jose, Calif. For example, the CDO system may be combined with a thermal abatement system such as the Trinity system available from Guild Associates of Dublin, Ohio.

Because water and electricity are employed for abatement, no combustible or flammable fuel such as methane or hydrogen is required.

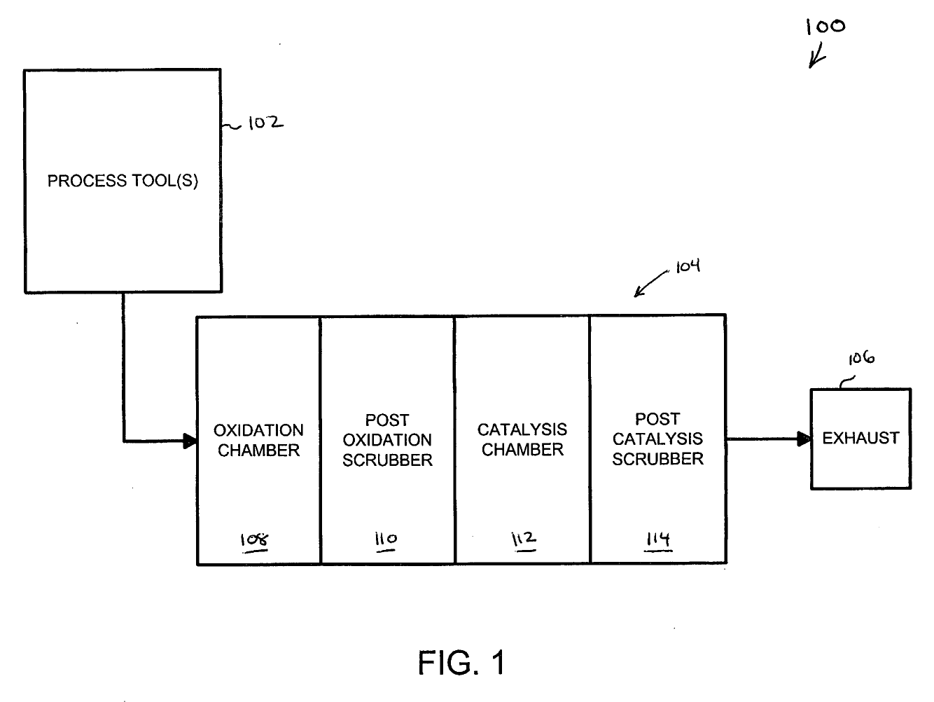

Exemplary embodiments of the invention are described below with reference to FIGS. 1-10.

FIG. 1 is a schematic diagram of a first exemplary processing system 100 provided in accordance with the present invention. With reference to FIG. 1, the processing system 100 includes one or more processing tools 102 coupled to an abatement system 104. The abatement system 104 is coupled to an exhaust 106 (e.g., house exhaust).

The one or more processing tools 102 may include, for example, one or more etch chambers, deposition chambers, or the like for use in semiconductor device manufacturing. The abatement system 104 may be employed to abate a single process chamber or tool, or multiple process chambers and/or tools.

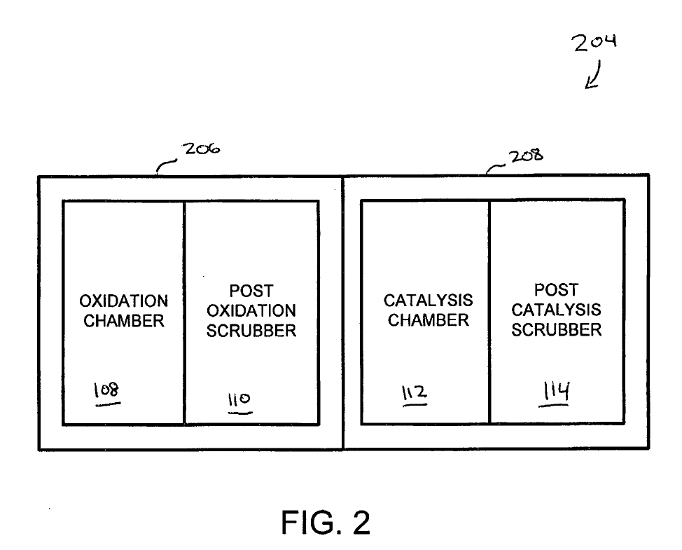

As shown in FIG. 1, the abatement system 104 includes an oxidation chamber 108 coupled to the one or more process tools 102, a post oxidation scrubber 110 coupled to the oxidation chamber 108, a catalysis chamber 112 coupled to the post oxidation scrubber 110 and a post catalysis scrubber 114 coupled to the catalysis chamber 112 and the exhaust 106. Exemplary embodiments of the oxidation chamber 108, post oxidation scrubber 110, catalysis chamber 112 and post catalysis scrubber 114 are described below with reference to FIGS. 2-5.

In operation, one or more gaseous waste streams are produced by the processing tool(s) 102 and are passed to the oxidation chamber 108. For example, the gaseous waste streams may be generated from an etching, deposition, cleaning or other semiconductor device manufacturing process performed within the processing tool(s) 102. Within the oxidation chamber 108, a reagent, such as hydrogen, is combined with each gaseous waste stream and the resultant mixture is heated to an appropriate temperature and converted to a more treatable form. For example, a halogen-containing gas may be combined with a reagent such as hydrogen to produce an acid gas (e.g., HF for fluorine, HCl for chlorine), which may then be removed by scrubbing within the post oxidation scrubber 110. Flammable and pyrophoric materials, HAPs and VOCs may be similarly abated.

Exemplary reagents include, for example, hydrogen, hydrocarbons such as methane, propane, natural gas, etc., ammonia, air, oxygen, water vapor, alcohol, ethers, calcium compounds, amines, mixtures of these gases, liquids and/or solids, and the like, although other reagents may be used. Exemplary temperatures for abatement and/or conversion of gaseous waste streams to more treatable forms range from about 650 to 950° C., although other temperature ranges may be used.

Within the post oxidation scrubber 110, solid byproducts of oxidation (e.g., SiO2, WO3, etc.), acids and/or particulates may be removed from a gaseous waste stream. For example, the reaction of fluorine or chlorine with hydrogen within the oxidation chamber 108 may produce acid gas such as HF or HCl that may be removed via water scrubbing within the post oxidation scrubber 110.

After being scrubbed within the post oxidation scrubber 110, a gaseous waste stream enters the catalysis chamber 112. Within the catalysis chamber 112, additional abatement of the gaseous waste stream occurs. For example, PFCs, as well as residual halogens (e.g., fluorine), HAPs and/or VOCs, are abated via a reaction between the gaseous waste stream and a catalyst present in the catalysis chamber 112. (Water vapor present within the gaseous waste stream from post oxidation scrubber 110 may assist in the abatement process as described further below.)

As an example, the catalytic chamber 112 may include a catalytic surface that catalyzes a reaction for reducing the hazardous gas content in a gaseous waste stream. The catalytic surface may be, for example, a structure made from catalytic material or supporting a finely divided catalyst, a bed of foam or pellets, or a coating on a wall or component of the catalytic chamber 1112. For example, the catalytic surfaces may comprise surfaces of a support structure comprising a honeycomb member with the catalyst embedded therein to form a high surface area member over and through which the effluent passes as it flows from an inlet to an outlet of the catalyst chamber 112. The catalytic surfaces may be on, for example, a structure comprising a ceramic material, such as cordierite, Al₂O₃, alumina-silica, mullite, silicon carbide, silicon nitride, zeolite, and their equivalents; or may comprise a coating of materials, such as ZrO₂, Al₂O₃, TiO₂ or combinations of these and other oxides. The catalytic surfaces may also be impregnated with catalytic metals, such as Pt, Pd, Rh, Cu, Ni, Co, Ag, Mo, W, V, La or combinations thereof or other materials known to enhance catalytic activity.

After a gaseous waste stream leaves the catalysis chamber 112, the gaseous waste stream enters the post catalysis scrubber 114. Within the post catalysis scrubber 114, soluble byproducts of catalysis, acids, and the like are removed from the gaseous waste stream(s). Thereafter, any resultant gaseous waste stream is supplied to the exhaust 106. (Note that the exhaust 106 may include additional abatement and/or scrubbing as needed.)

FIG. 2 is a schematic diagram of a first exemplary embodiment of the abatement system 104 of FIG. 1, referred to as abatement system 204 in FIG. 2. With reference to FIG. 2, the abatement system 204 is similar to the abatement system 104 of FIG. 1 and includes the oxidation chamber 108, the post oxidation scrubber 110, the catalysis chamber 112 and the post catalysis scrubber 114. However, in FIG. 2, the abatement system 204 is formed by retrofitting an oxidation system 206 (that includes oxidation chamber 108 and post oxidation scrubber 110) with a catalysis system or “catalytic backpack” 208 (that includes catalysis chamber 112 and post catalysis scrubber 114).

In one or more embodiments, the abatement system 204 may be formed by retrofitting the controlled decomposition and oxidation (CDO) system available from the Ecosys division of Metron Technology of San Jose, Calif. with a thermal abatement system such as the Trinity system available from Guild Associates of Dublin, Ohio. U.S. Pat. Nos. 6,261,524 and 6,423,284 describe exemplary oxidation systems that may be retrofitted with a suitable catalysis system, such as those described in U.S. Pat. Nos. 6,468,490 and 6,824,748. Each of these patents is hereby incorporated by reference herein in its entirety for all purposes.

The above described CDO system is an electric oxidation furnace that removes flammables, pyrophorics, HAPs and/or VOCs from a gaseous waste stream (e.g., using hydrogen or another suitable reagent). A post oxidation scrubber within the CDO system removes oxidation byproducts, acids and other particulates. A catalytic backpack system coupled to an oxidation system (such as the CDO system) may be used to abate PFCs and additional HAPs or VOCs not abated by the oxidation system, remove acids and soluble byproducts of catalysis, etc., through the catalyst chamber and scrubber of the catalytic backpack system (e.g., via co-current and/or counter-current water scrubbers). The additional HAP and VOC abatement properties of the catalysis system may significantly increase the bandwidth and/or lifetime of the overall abatement system as described further below.

In at least one embodiment, a control and interlock system may be provided within the catalytic backpack which communicates with the oxidation system 206, process tool(s) 102 and pumps of the processing system 100 to ensure minimum tool/system impact. For example, the control system may monitor and/or regulate inlet pressure to the abatement system 104 so that any process tools coupled to the abatement system experience no variations due to the abatement system. In the same or other embodiments, an existing water train of the oxidation system may be employed by the catalytic backpack (as described below). For example, the catalytic backpack may discharge liquid waste streams, such as H2O:HF waste, to a sump of the oxidation chamber.

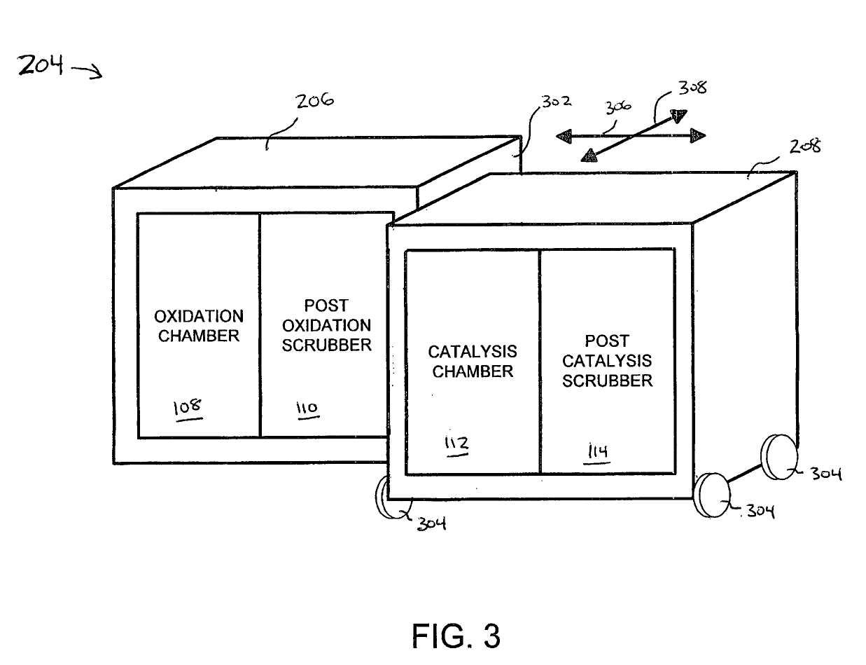

In some embodiments, such as when a catalytic backpack is coupled to a CDO system, serviceability of the underlying oxidation system may be reduced by the presence of the catalytic backpack. For example, the CDO system typically is serviced from the post oxidation scrubber side of the CDO unit. Accordingly, it may be desirable to install the catalytic backpack in a manner that allows easy removal and/or adjustment of the position of the catalytic backpack during oxidation system servicing. For example, FIG. 3 is a side perspective view of the abatement system 204 in which the catalytic backpack 208 has been moved so as to provide service access to a post oxidation scrubber side 302 of the oxidation system 206. The catalytic backpack 208 may be, for example, provided with wheels 304, coasters, rollers, rails, etc., that allow the catalytic backpack 208 to be displaced relative to the oxidation system 206 as indicated by arrows 306, 308. Appropriate electrical cabling and/or plumbing fixtures may be added to allow for such lateral displacement of the catalytic backpack 208 relative to the oxidation system 204. Forward displacement (arrow 308) of the catalytic backpack 208 relative to the oxidation system 206 allows front access to the oxidation chamber 108, side access to the post oxidation scrubber 110, front access to the catalysis chamber 112 and side access to the post catalysis scrubber 114.

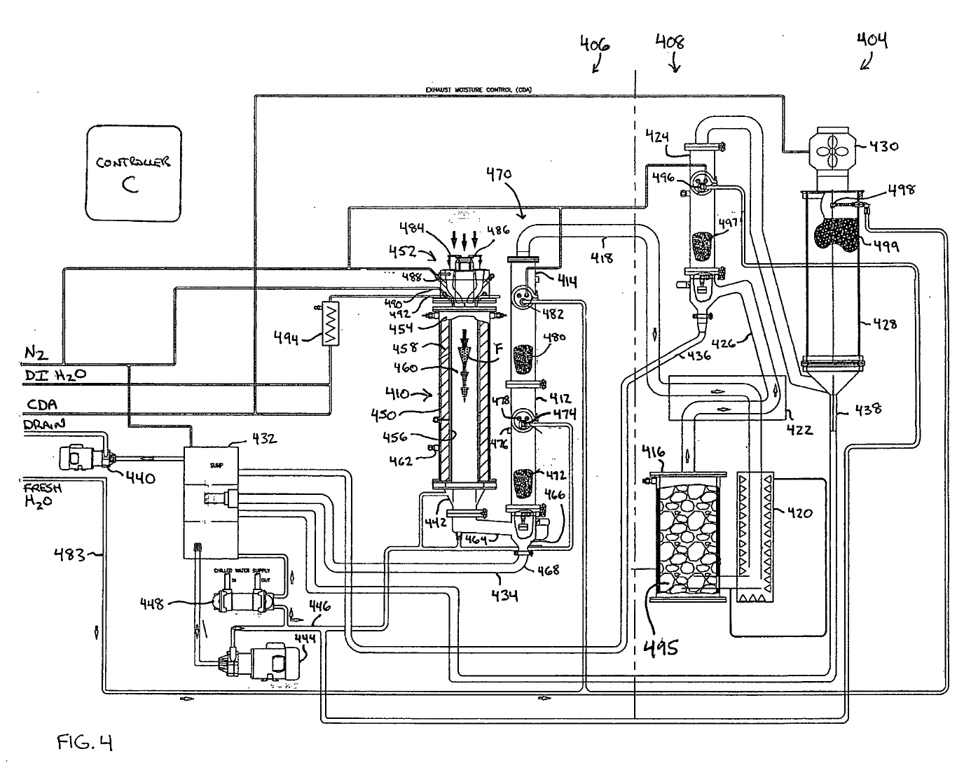

FIG. 4 is a schematic diagram of a second exemplary embodiment of the abatement system 104 of FIG. 1, referred to as abatement system 404 in FIG. 4. The abatement system 404 is similar to the abatement system of FIG. 2, and includes an oxidation system 406 coupled to a catalytic system or backpack 408.

The oxidation system 406 includes an oxidation chamber 410 coupled to a first (water) scrubber 412. A second (water) scrubber 414 is coupled to the first scrubber 412 and the catalytic backpack 408 (as described below).

The catalytic backpack 408 includes a catalyst chamber 416 coupled to the second scrubber 414 of the oxidation system 406 via a first conduit 418 that travels through a first heater 420 and a first heat exchanger 422 (as shown). The catalytic chamber 416 is also coupled to a third (water) scrubber 424 via a second conduit 426 that travels through the first heat exchanger 422. A fourth (water) scrubber 428 is coupled to the third scrubber 424 and to a blower 430. The blower 430 may be, for example, coupled to the house exhaust (e.g., exhaust 106 in FIG. 1). An eductor or similar device for creating a draw or flow through the abatement system 404 may be employed in place of the blower 430.

The oxidation chamber 410, the first scrubber 412 and the second scrubber 414 drain into a sump (tank) 432 via a first drain line 434. The catalytic backpack 408 may employ its own drain/sump. However, in the embodiment of FIG. 4, the third scrubber 424 and fourth scrubber 428 of the catalytic backpack 408 drain into the sump 432 via a second drain line 436 and a third drain line 438, respectively.

A sump pump 440 is coupled to the sump 432 and may be employed to pump waste from the sump 432 (e.g., to a house or other drain). Water from the sump 432 may be recirculated and supplied to a cooling section 442 (e.g., a liquid vortex described below) of the oxidation chamber 410, the initial scrubber 412 of the oxidation system 406 and to the initial scrubber 424 of the catalytic backpack 408 via a recirculation pump 444 and a recirculated water line 446. Such recirculated water may be cooled via a second heat exchanger 448 or similar mechanism. Alternatively, fresh water may be supplied to the scrubbers 412, 424. Likewise, fresh (as shown) or recirculated water may be supplied to the final scrubbers 414, 428 of the oxidation system 406 and catalytic backpack 408, respectively.

In the embodiment of FIG. 4, the oxidation cha chamber 410 includes a thermal oxidation reactor 450, to which is joined an inlet assembly 452 for delivery of process gases and ancillary fluids to the reactor 450. The thermal oxidation reactor 450 includes an exterior wall 454 and an interior wall 456 enclosing an annular or otherwise shaped heating element 458. The interior wall 456 encloses a central flow passage 460 of the reactor. The heating element 458 may be, for example, electrically heated to provide a hot surface at the interior wall 456, for elevated temperature treatment of the effluent being treated. The inner wall 456, or “liner,” may be formed of any suitable material, such as a nickel-alloy (e.g., Inconel® metal alloy).

The thermal oxidation reactor 450, although illustratively shown as an electrically heated unit, may alternatively be of any suitable type. Examples of alternative types include flame-based thermal oxidizers (e.g., using oxygen as an oxidizer and hydrogen or methane as the fuel), catalytic oxidizers, transpirative oxidizers, etc. The thermal oxidizer may be heated in any suitable manner, such as by electrical resistance heating, infrared radiation, microwave radiation, convective heat transfer or solid conduction.

The thermal oxidization reactor 450 may be equipped with a control thermocouple (not shown). The thermocouple is used to monitor the temperature of the heating element 458. The thermocouple may be arranged in suitable signal transmission relationship to a thermal energy controller (not shown). Such thermal energy controller may in turn be arranged to responsively modulate the electrical heating energy to the annular heating element 458, and thereby achieve a desired temperature of the hot wall surface of interior wall 456. In such manner, the wall surface can be maintained at a desired temperature level appropriate for the thermal oxidation treatment of the effluent flowed through the thermal oxidizer unit (in the direction indicated by arrow F in FIG. 4).

The thermal oxidation reactor 450 in the embodiment shown is adapted to receive clean dry air (CDA) at a CDA inlet 462 from a CDA supply line (not shown). The CDA supply line may be joined in supply relationship to a suitable source of clean dry air. The thus-introduced air flows into the annular space between outer wall 454 and inner wall 456 of the thermal oxidizer unit, and is heated to a suitable temperature in contact with the heating element 458. Resultant heated air then may flow through orifices or pores (not shown) in the inner wall 456 into the central flow passage 460 of the reactor. In this manner, the oxidant may be added to mix with the effluent gas and form an oxidizable effluent gas mixture for thermal oxidation in the reactor 450. Alternatively (or additionally), the oxidant may be added at the inlet assembly 452, as another introduced fluid stream, to support the oxidation reactions in the thermal oxidation reactor 450.

At its lower end, the thermal oxidizer unit 450 is joined to the cooling section 442 (e.g., a quench unit). In some embodiments, in the cooling section 442, an array of water spray nozzles (not shown) may be provided, supplied with water by an associated water feed conduit, such as recirculated water line 446. The water spray nozzles serve to provide initial quench cooling to the hot effluent gas stream as the stream is discharged from the thermal oxidizer unit into the cooling section 442. Additionally or alternatively, the cooling section 442 may include a liquid vortex (not shown) for cooling the exiting gas stream, such as the liquid vortex described in previously incorporated U.S. Pat. No. 6,261,542.

The cooling section 442 includes a transverse section 464 which extends to the first scrubber 412. The transverse section 464 in turn is joined to a sump section 466 of the cooling section 442. The sump section 466 at its lower end is coupled to a slope drain/vapor barrier 468. A conductivity liquid level sensor/chamber purge assembly (not shown) may be joined to the sump section 466, and coupled to a CDA branch line which provides clean dry air to the assembly.

At its upper end, the sump section 466 of the cooling section 442 is coupled to a lower end of a scrubber demister column 470 formed by the first and second scrubbers 412, 414. The scrubber demister column 470 may be filled, in the lower secondary cooling/scrubbing section 412 thereof, with a secondary scrubbing packing 472. The upper portion of the first scrubber 412 of the column 470 is equipped with a water spray nozzle 474 for effecting scrubbing of the upflowing effluent gas therein, by countercurrently flowing water downwardly over the packing 472. A co-current water flow alternatively may be used. The water spray nozzle 474 is supplied with water by recirculated water line 446, although fresh water may be used.

The upper portion of the first scrubber 412 may be equipped with a vapor relief port 476 to which is coupled a vapor relief line (not shown), for venting overpressure in the column 470. An exhaust temperature sensor 478 also may be mounted on the upper portion of the first scrubber 412, to provide temperature monitoring capability for the column 470.

The second scrubber 414 of the scrubber demister column 470 is likewise filled with a secondary scrubbing packing 480 and is equipped with a water spray nozzle 482 coupled to a fresh water feed line 483. In some embodiments, the fresh water feed line 483 may include a valve (not shown) therein that may be actuated as necessary to provide additional scrubbing capability for treatment of a specific effluent gas stream. In an alternative embodiment, the second scrubber 414 may be recirculated water.

The second scrubber 414 of the scrubber demister column 470 may be coupled to an exhaust temperature sensor (not shown), for monitoring the temperature of the effluent gas stream. A pressure display (not shown) also may be coupled to the second scrubber 414 of the scrubber demister column 470 for monitoring pressure within the column 470.

In some embodiments, clean dry air may be supplied to the column 470, e.g., for dilution of the effluent stream being discharged from the upper end of the column 470. A restricted flow orifice (not shown) and/or a flow control valve (not shown) upstream of the orifice, may be used to selectively restrict flow of CDA to the upper end of the column 470.

The inlet assembly 452 for delivery of process gases and ancillary fluids to the thermal oxidation reactor 450 may be arranged as shown, with process gas inlet conduits 484 and 486 receiving process exhaust gas from one or more process chambers. The process gas inlet conduits 484 and 486 flow effluent process exhaust gas into the thermal oxidation reactor 450. These process gas inlet conduits may be constructed with one or more ancillary fluid addition lines, such as fluid line 488, for addition of ancillary process fluids to the main effluent stream being flowed through the process gas inlet conduits 484 and 486.

The inlet assembly 452 may also include a shroud gas feed line 490 and a hydrogen or reagent source feed line 492. The reagent source feed line 492 is joined to a reagent source gas supply, such as a water and/or CDA supply. The shroud gas may be a purge gas for the thermal oxidation reactor 450, or the inlet or associated piping and channels of the effluent abatement system. Illustrative shroud or purge gas species include nitrogen, helium, argon, etc.

In some embodiments, water vapor (steam) is introduced as a hydrogen source gas to the thermal oxidation reactor 450. The water vapor is utilized at an elevated temperature appropriate to the thermal oxidation process being carried out in the thermal oxidation reactor 450 and/or the halogen components being abated in the effluent gas. A vaporization unit 494 (e.g., a heater) may be supplied with water from a suitable feed source, such as a water line in the semiconductor manufacturing facility, a municipal or industrial water supply, or the like. Alternatively, a hydrogen source gas supply may comprise a steam line in a semiconductor manufacturing facility or another source of water vapor. As a still further alternative, a hydrogen source gas supply may comprise a chemical reaction vessel for reacting reagent materials to form water vapor. For example, a hydrocarbon reagent, such as methane, propane, natural gas, etc., may be introduced to the chemical reaction vessel for mixing and reaction with an independently introduced oxidant, e.g., an oxygen-containing gas such as air, oxygen, oxygen-enriched air, ozone, or the like, to produce water vapor as a reaction product.

Water vapor may be employed to provide a source of hydrogen in the thermal oxidation reactor 450, for reaction with the halogen constituents of the effluent gas such as fluorine and fluorinated species, bromine, iodine and chlorine, and to corresponding other halogen-containing compounds, complexes and radicals. For example, fluorine gas is readily converted by reaction with steam, to yield hydrogen fluoride, which is easily removed from the effluent gas in a scrubbing step. The scrubbing step also removes various other acid gas components of the effluent, to produce a halogen-reduced/acid gas-reduced effluent.

Fluorine or other halogens in the effluent gas flowed into an effluent abatement system of the type shown in FIG. 4, with steam injection at the inlet of the reactor, will be abated in the upper section of the reactor 450 (e.g., before the halogens have a chance to attack the thermal section). In some embodiments, water vapor may be injected between the stream of process gas and the liner 456 of the thermal oxidation reactor 450 to protect the liner 450 from attack.

Exemplary embodiments for the design of the inlet assembly 452 are described in previously incorporated U.S. Pat. Nos. 6,261,524 and 6,423,284. Other suitable inlet designs may be used.

Exemplary temperatures for the use of water vapor or CH₄ as a hydrogen source reagent are between 650° C. and 950° C., with the lower temperatures decreasing the corrosion rate and F₂ attack on the liner 456. Other temperature ranges may be used.

In at least one embodiment, the oxidation system 406 is similar to the oxidation system described in previously incorporated U.S. Pat. No. 6,423,284, and operates similarly thereto. Other oxidation systems also may used.

After a gaseous waste stream has been oxidized within the oxidation chamber 410, the waste stream is scrubbed via the first and second scrubbers 412, 414. The gaseous waste stream then travels to the catalytic chamber 416 via the conduit 418.

An additional benefit of the first and second scrubbers 412, 414 is that the gaseous waste stream is prescrubbed before entering the catalyst chamber 416. Such prescrubbing removes gaseous or particulate components of the gaseous waste stream that can damage the catalytic chamber 416 or make it less effective. For example, when SiF₄ is present in the gaseous waste stream, the SiF₄ can potentially deactivate the catalyst or form deposits on the catalyst by breaking up in the presence of moisture and depositing silicon. SiF₄ vapor is often generated, for example, during etching and cleaning processes. Scrubbing a waste stream with a scrubbing fluid, for example water, reduces the content of SiF₄ in the waste stream (e.g., by producing SiO2 and HF). The resultant SiO₂ and HF products are more easily removable from the gaseous waste stream. The HF may be dissolved in water and the SiO₂ may be removed by filtering.

The catalytic chamber 416 may include a catalytic surface 495 that catalyzes a reaction for reducing the hazardous gas content in a gaseous waste stream. The catalytic surface 495 may be, for example, a structure made from catalytic material or supporting a finely divided catalyst, a bed of foam or pellets, or a coating on a wall or component of the catalytic chamber 416. For example, the catalytic surface may comprise surfaces of a support structure comprising a honeycomb member with the catalyst embedded therein to form a high surface area member over and through which the effluent passes as it flows from an inlet to an outlet of the catalyst chamber 416. The catalytic surface 496 may be on, for example, a structure comprising a ceramic material, such as cordierite, Al₂O₃, alumina-silica, mullite, silicon carbide, silicon nitride, zeolite, and their equivalents; or may comprise a coating of materials, such as ZrO₂, Al₂O₃, TiO₂ or combinations of these and other oxides. The catalytic surface may also be impregnated with catalytic metals, such as Pt, Pd, Rh, Cu, Ni, Co, Ag, Mo, W, V, La or combinations thereof or other materials known to enhance catalytic activity.

As the gaseous waste stream travel from the second scrubber 414 to the catalytic chamber 416, first cross heat exchanger 422 and/or heater 420 (e.g., an electric, gas or other heater) heats the gas stream to a temperature sufficient to promote the catalytic reaction and abate the hazardous gases in the catalytic chamber 416. Heat may improve the abatement efficiency and extend the life of the catalyst. Temperatures at or less than about 700° C., or in the range from about 50° C. to about 300° C., may be used, as may other temperature ranges.

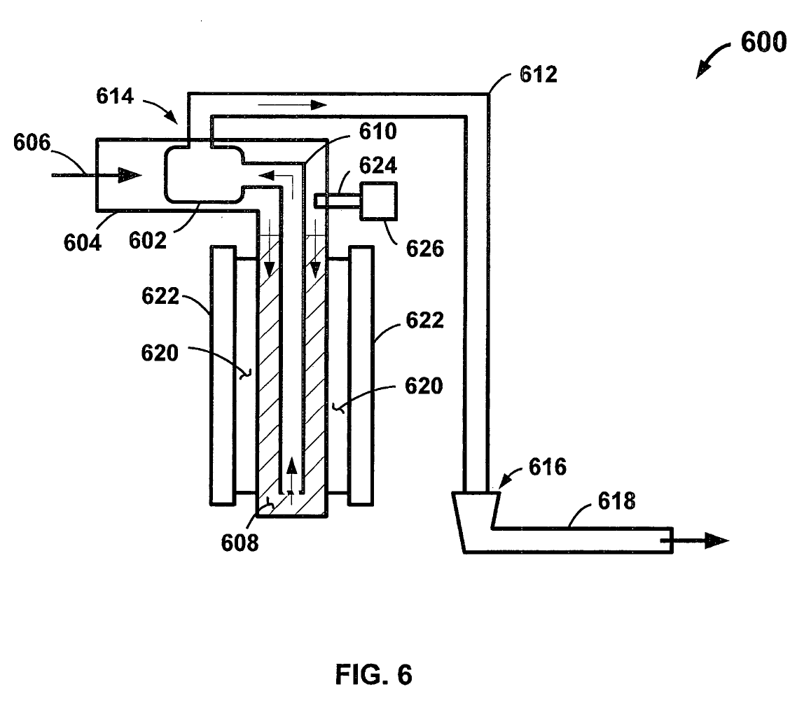

The first cross heater exchanger 422 may comprise any suitable cross heater exchanger for recovering heat produced at the output of the catalyst chamber 416 for use in heating the gaseous waste stream being input to the catalyst chamber 416. Exemplary embodiments for the cross heat exchanger 422 are described below with reference to FIGS. 6-10.

As stated, a gaseous waste stream passes through the catalytic chamber 416 to abate hazardous gases in the gas stream. If the waste stream is heated, the abated waste stream may also be cooled before it is scrubbed and exhausted. In some embodiments, a cooling system such as a cold water quenching system (not shown) that sprays cold water to cool the abated gas stream may be employed. The abated gas stream is then introduced into the third scrubber 424 where the acidic materials in the abated gaseous waste stream are dissolved in a solvent, such as for example water, to form an acidic solution that is more easily exhausted or disposed.

During fluorine abatement, HF is produced in the catalytic chamber 416. The presence of HF in the gaseous waste stream may pose safety concerns and handling difficulties because HF is toxic and should not come into contact with skin. Additionally, HF is highly corrosive, particularly at elevated temperatures and in the presence of moisture and oxygen. Nickel-based alloys, for example Inconel® 600 or 625™, provide excellent corrosion resistance in a catalytic abatement environment and may be reliably sealable and gas tight to prevent unwanted HF escape from the system.

As the gaseous waste stream passes through the third scrubber 424, a water nozzle 496 dispenses scrubbing fluid, for example water, supplied via the recirculated water line 446 (or via a fresh water line) into the gaseous waste stream. In at least one embodiment, the fluid dispensing is done by spraying water in a direction which is countercurrent to the flow of gas. By “countercurrent” it is meant that at least a portion of the flow is in a direction substantially opposing the general direction of the flow of the gas. This arrangement allows for gravity and the flow of water to encourage transport of reactant products, for example silicon dioxide particles and HF, into the sump 432. Alternatively, a co-current direction may be used. The third scrubber 424 may optionally be provided with surface area increasing material or other packing 497, for example plastic or ceramic pellets or granules of differing sizes, such as for example PVC balls, for increasing the surface area of water/gas contact in the column and thereby encouraging various destruction reactions.

The gaseous waste stream passes through the third scrubber 424 and travels to the fourth scrubber 428. The fourth scrubber 428 may include a spray nozzle 498 for dispensing scrubbing fluid, for example by spraying water, from the fresh water line 483 countercurrently into the waste stream. Alternatively, a co-current direction and/or recirculated water may be used.

The fourth scrubber 428 may further have surface area increasing material or packing 499 similar to packing of the other scrubbers within the system 404. The fourth scrubber 428 provides yet another level of scrubbing of the gaseous waste stream, with fresh water, and further serves to transport reaction products to the sump 432.

The blower 430 may be used to create a draft or negative pressure that draws the gaseous waste stream out of the abatement system 204. As stated, an eductor or other mechanism also may be used. CDA or another dry gas may be added at or near the blower 430 to regulate exhaust moisture and/or to dilute the exhaust stream. If an eductor is used, a dry gas may be employed for the drive gas and reduce exhaust dew point and/or dilute the exhaust stream.

A controller C may be coupled to and adapted to control operation of the abatement system 404. The controller C may include one or more microprocessors, microcontrollers, dedicated hardware circuits, a combination thereof, etc. In at least one embodiment, the controller C is an appropriately programmed microprocessor. For example, when a catalytic backpack is employed with an existing oxidation system, the controller of the oxidation system may be programmed to control operation of the catalytic backpack (e.g., via additional programmable logic controllers or suitable hardware).

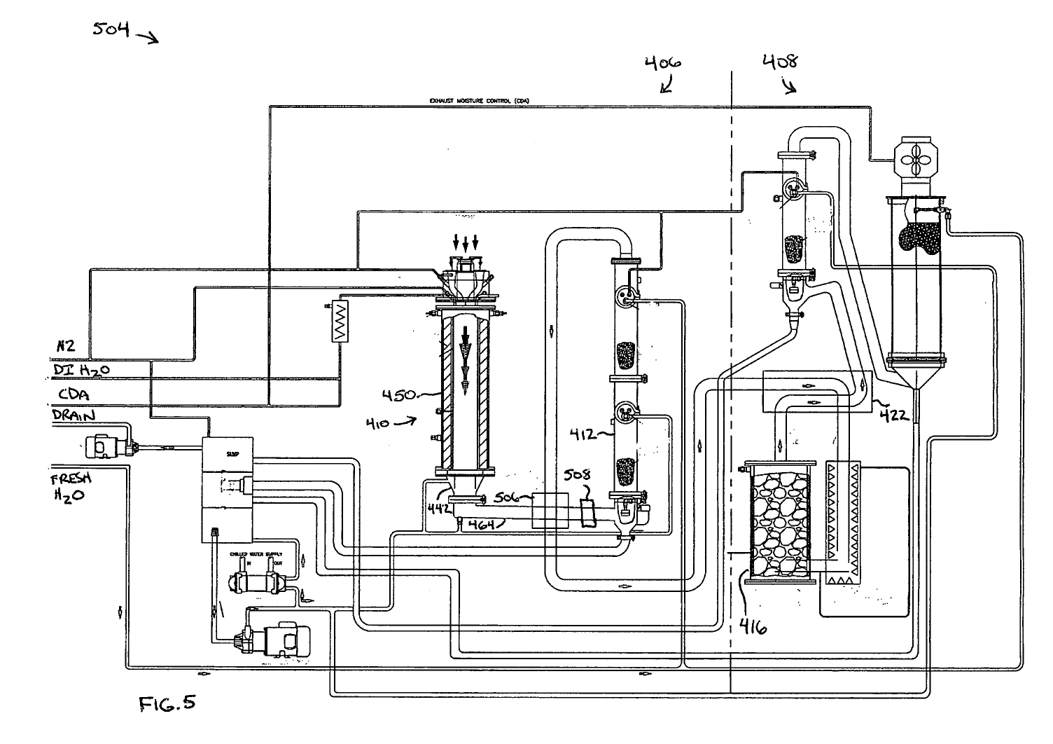

FIG. 5 is a schematic diagram of an alternative embodiment of the abatement system 404 of FIG. 4, referred to as abatement system 504 in FIG. 5. The abatement system 504 of FIG. 5 is similar to the abatement system 404 of FIG. 4, but includes a number of additional features. For example, in at least one embodiment, the abatement system 504 includes an additional cross heat exchanger 506. The cross heat exchanger 506 is positioned within the transverse section 464 of the cooling section 442 of the oxidation chamber 410 and is adapted to recover heat generated at the output of the thermal oxidation reactor 450 and use the recovered heat to pre-heat any gaseous waste stream traveling into the catalyst chamber 416. The cross heat exchanger 506 is upstream from the first cross heat exchanger 422 and provides an additional source of heat for any gaseous waste stream prior to entry into the catalyst chamber 416 (in addition to the heat provided by the cross heat exchanger 422 and the heater 420). The cross heat exchanger 506 may be similar to the first heat exchanger 422, although any suitable heat exchanger may be used. Exemplary heat exchangers are described below with reference to FIGS. 6-10.

In some embodiments, an additional wet scrubber 508, such as a high pressure scrubber, may be employed before the first scrubber 412 of the oxidation system 406. For example, the wet scrubber 508 may include a plurality spray nozzles (not shown) adapted to create a water curtain through which a gas waste stream passes. An inlet/conduit (not shown) of the wet scrubber 508 may be arranged so as to direct a gaseous waste stream approximately tangentially along an inner surface of the water scrubber 508. Such an arrangement increases the residence time of gaseous waste streams within the wet scrubber 508 thereby increasing the effectiveness of any water scrubbing process performed therein. Other inlet/conduit configurations may be used.

Water and/or other gases and/or fluids may be dispensed radially into an inner cavity of the water scrubber 508 via spray nozzles (not shown). The spray nozzles may be atomizer type spray nozzles and may dispense a high pressure mist of water droplets. In some embodiments, spray nozzles may dispense water droplets of a diameter of about 10 to 100 microns, and more preferably about 50 microns or less. Larger and/or smaller water droplet sizes may be dispensed. In at least one embodiment of the wet scrubber 508, atomizing water nozzles are employed to produce drops of about a 10 to 100 micron diameter so as to create an approximately 0.1 to 5 second, and preferably about 2.5 to 5 second, contact time between water particles and the gaseous waste stream. Spray nozzles and/or other water dispensers may also direct a water curtain along the various surfaces of the inner cavity of the wet scrubber 508 to prevent deposition of particulates on these surfaces.

In some embodiments, water droplets dispensed by spray nozzles may be electrostatically enhanced. That is, biasing electrodes may charge water droplets dispensed by spray nozzles to prevent the water droplets from coalescing. Other systems and/or methods to control water droplet size, direction of travel, and/or formation may be employed in wet scrubber 508.

FIG. 6 illustrates a schematic view of a first apparatus 600 for heating a catalyst bed, such as the catalyst chamber 416 of FIGS. 4-5, provided in accordance with the present invention. With reference to FIG. 6, the first apparatus 600 includes a heat exchanger 602 inside of a reactor pipe 604 adapted to convey a waste stream (e.g., process by-products) entering in the direction shown by an arrow 606. The reactor pipe 604 may also have an abatement bed 608, such as a catalyst bed, in a portion of the reactor pipe 604. In this embodiment, the abatement bed 608 may be disposed about an inner pipe 610. As shown in FIG. 6, the inner pipe 610 may be coupled to the heat exchanger 602. The heat exchanger 602 may also be coupled to an exhaust pipe 612 through a wall of the reactor pipe 604 at an interface 614. The exhaust pipe 612 may be coupled to a quench 616. For example, the quench 616 may be the scrubbers 424 and/or 428 of catalytic backpack 408 of FIG. 4. The quench 616 may be coupled to a waste pipe 618 adapted to dispose of the treated waste stream (e.g., to the sump 432 of FIG. 4).

The first apparatus 600 may also include a reactor heater 620 and an insulator 622 disposed about the reactor pipe 604. As shown in FIG. 6, the reactor heater 620 and the insulator 622 are depicted in cross section views. A waste stream heater 624 may be disposed inside the reactor pipe 604. The waste stream heater 624 may be coupled to a power supply 626.

The heat exchanger 602 may be a coiled pipe of a steel alloy such as a Nickel-based alloy, for example Inconel 600 or 625™ available from Inco Corporation in Huntington, W. Va., although any suitable shape and/or material may be employed. For example, although a coil shape may be employed in the present embodiment, in the same or alternative embodiments a multi-fin shape may be used. Also, the material may be any suitable material adapted to carry a waste stream and transfer heat between a region inside the heat exchanger 602 and a region outside the heat exchanger 602. In some embodiments, the waste stream temperature may be about 800 to about 900 degrees Celsius although higher or lower temperatures may be present.

Similarly, the reactor pipe 604, the inner pipe 610, the exhaust pipe 612, and the waste pipe 618 may be formed from Inconel 600 or 625™, although any suitable material may be used. For example, in some embodiments a less expensive stainless steel alloy may be employed in the exhaust pipe 612 when the properties (e.g., corrosiveness, temperature, etc.) of the waste stream are not detrimental to the stainless steel. Although the reactor pipe 604, the inner pipe 610, the exhaust pipe 612, and the waste pipe 618 may be round pipes, in general, any suitable shape and/or sizes may be employed. The temperature of the waste stream carried by the reactor pipe 604, the inner pipe 610, the exhaust pipe 612, and the waste pipe 618 may range from about room temperature to about 900 degrees Celsius although higher or lower temperatures may be present.

The reactor heater 620 may be a ceramic heater from, for example, the ceramic heater product line available from Watlow Corporation in St. Louis, Mo., although any suitable heater may be employed. The ceramic portion of the reactor heater 620 may provide some insulation. To provide additional insulation, the insulator 622 or any suitable insulation may be provided. The insulator 622 may also prevent injuries to operators and/or damage to equipment. As shown in FIG. 6, the insulator 622 may be wrapped around the reactor heater 620 although any suitable configuration of the reactor heater 620 and the insulator 622 may be employed to heat the reactor pipe 604 and the waste stream.

The waste stream heater 624 may be an electric heating device although any suitable heating device may be employed. As shown in FIG. 6, the waste stream heater 624 may have a portion inside the reactor pipe 604 so as to contact the waste stream inside the reactor pipe 604. Although FIG. 6 depicts the waste stream heater 624 as a rod, other configurations may be employed in the same or alternative embodiments. The waste stream heater 624 may be at a temperature that is higher than the temperature of the waste stream. Accordingly, the waste stream heater 624 may heat the waste stream around the waste stream heater 624 to a desired temperature. The waste stream heater 624 may heat the waste stream by using electricity supplied by the power supply 626 although any suitable power source may be employed.

In operation, the waste stream may enter the reactor pipe 604 as depicted by the arrow 606, and flow about the outer surface of the heat exchanger 602. As will be explained below, the heat exchanger 602 may be at a temperature that is greater than the temperature of the waste stream. Accordingly, heat is transferred from the heat exchanger 602 to the waste stream to heat the waste stream. The waste stream may flow past the heat exchanger 602 and the waste stream heater 624. The waste stream heater 624 may be at a temperature higher than the heat exchanger 602 although any suitable temperature may be employed. The waste stream heater 624 may heat the waste stream to a desired temperature (e.g., for abatement). Subsequently, the waste stream may filter through the abatement bed 608 (e.g., catalyst chamber 416 in FIG. 4). During this filtering the waste stream may react (e.g., chemically, physically, etc.) with the abatement bed 608 so as to change the chemical composition of the waste stream to a more desirable chemical composition. The reaction may occur at an elevated temperature.

Note that, as shown in FIG. 6, the waste stream is heated by the heat exchanger 602 prior to being heated by the waste stream heater 624. Accordingly, the heat exchanger 602 may use the heat retained in the waste stream after the reaction with the abatement bed 608 to preheat the incoming waste stream.

After filtering through the abatement bed 608, the waste stream may flow through the inner pipe 610 into the heat exchanger 602. Because the waste stream may cool during the filtering, it may be at a temperature that is slightly less than the abatement temperature. However, the temperature of the waste stream after abatement is generally higher than the temperature of the entering waste stream. Accordingly, as discussed above, the heat exchanger 602 may heat the incoming waste stream. The abated waste stream may flow through the heat exchanger 602 and the exhaust pipe 612 towards the quench 616 (e.g., scrubbers 424 and/or 428 of the catalytic backpack 408 of FIG. 4). The quench 616 may further cool and/or abate chemistries in the waste stream. Subsequently, the waste pipe 618 may dispose of the waste stream (e.g., to the sump 432 of FIG. 4). A similar heat exchanger (e.g., absent the catalyst bed) may be used for the heat exchanger 506 of oxidation system 406 of FIG. 5.

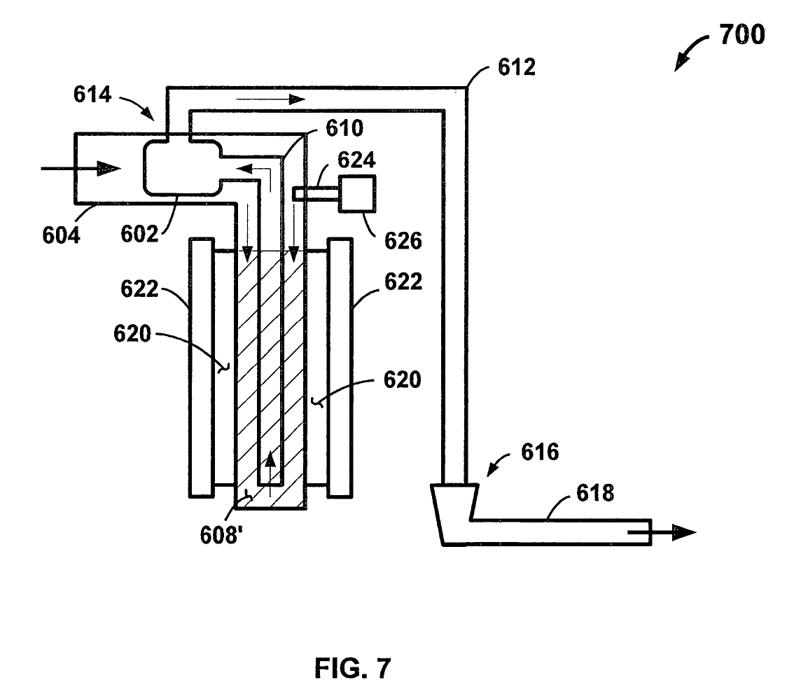

FIG. 7 illustrates a schematic view of a second apparatus 700 for heating a catalyst bed, such as the catalyst chamber 416 of FIGS. 4-5, provided in accordance with the present invention. With reference to FIG. 7, the second apparatus 700 may include an abatement bed 608′ (e.g., a catalyst bed) that may be similar to the abatement bed 608 of the first apparatus 600. As shown in FIG. 7, the second abatement bed 608′ is present inside the inner pipe 610.

In operation, the waste stream may flow similar to as described above with reference to FIG. 6. The waste stream flows through the second abatement bed 608′ along a path that is longer than as described with reference to FIG. 6. Accordingly, the waste stream may have greater reaction and/or residence times with the second abatement bed 608′. Accordingly, the chemical composition of the waste stream may be abated more extensively. A similar heat exchanger (e.g., absent the catalyst bed) may be used for the heat exchanger 506 of oxidation system 406 of FIG. 5.

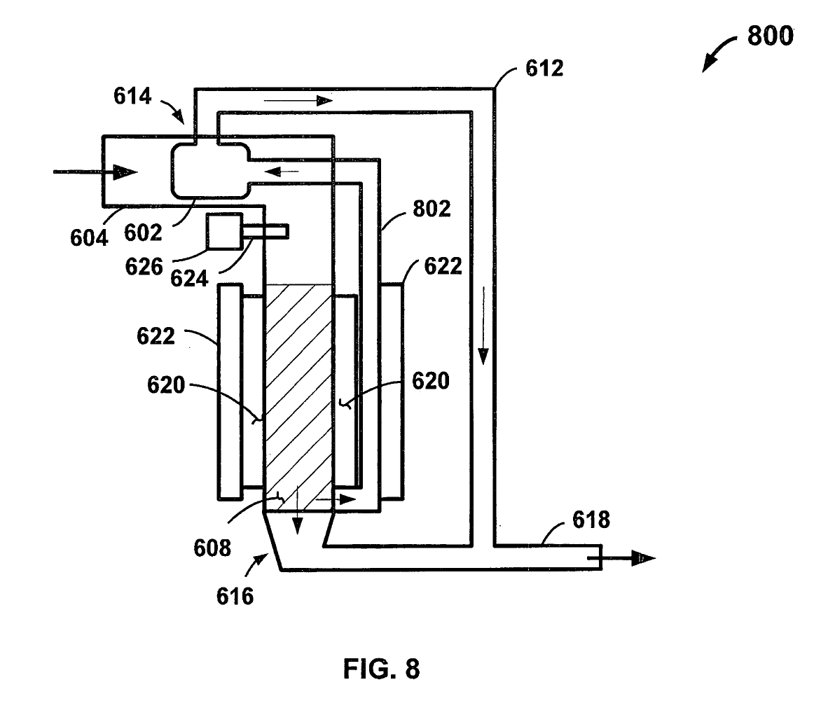

FIG. 8 illustrates a schematic view of a third apparatus 800 for heating a catalyst bed, such as the catalyst chamber 416 of FIGS. 4-5, provided in accordance with the present invention. With reference to FIG. 8, the third apparatus 800 may include an external pipe 802 coupled to the reactor pipe 604 and the heat exchanger 602. The third apparatus 800 may also include some components of the second apparatus 700. Note that the quench 616 is coupled to the reactor pipe 604. As shown in FIG. 8, a portion of the external pipe 802 may be disposed outside the reactor pipe 604 and between the insulator 622 and the reactor heater 620 although any suitable configuration may be employed. For example, in alternative embodiments, the external pipe 802 may be disposed between the reactor heater 620 and the reactor pipe 604. The external pipe 802 may be similar to the inner pipe 610 described above with reference to FIG. 6. For example, the external pipe 802 may be made of a nickel-alloy such as Inconel™ or another suitable material.

In operation, a waste stream may travel through the reactor pipe 604, through the abatement bed 608 and enter the external pipe 802 at an elevated temperature. The abated waste stream may be conveyed by the external pipe 802 between the reactor heater 620 and the insulator 622, thereby heating or preserving the temperature of the waste stream in the external pipe 802. Subsequently, similar to the first apparatus 600 and the second apparatus 700, the abated waste stream may flow into the heat exchanger 602 to heat the heat exchanger 602 to a temperature higher than the temperature of the incoming waste stream. Accordingly, the heat exchanger 602 may preheat the incoming waste stream as described above with reference to FIGS. 6 and 7. A similar heat exchanger (e.g., absent the catalyst bed) may be used for the heat exchanger 506 of oxidation system 406 of FIG. 5).

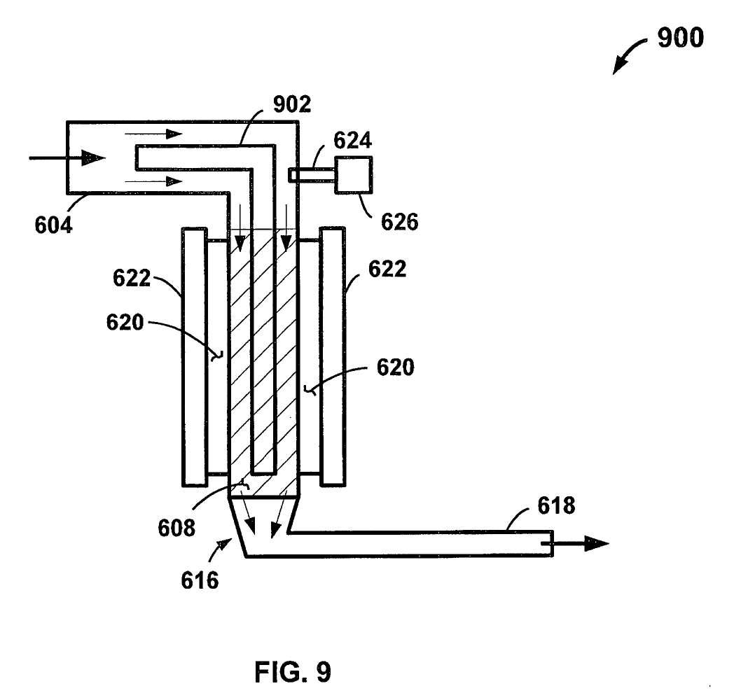

FIG. 9 illustrates a schematic view of a fourth apparatus 900 for heating a catalyst bed, such as the catalyst chamber 416 of FIGS. 4-5, provided in accordance with the present invention. With reference to FIG. 9, the fourth apparatus 900 may include a pipe 902 in addition some of the components described above with reference to FIG. 6. The pipe 902 may be disposed in the abatement bed 608 inside the reactor pipe 604. As shown in FIG. 9, the pipe 902 is disposed approximately center in the abatement bed 608 although any suitable location may be employed. A portion of the pipe 902 extends beyond the abatement bed 608 into a region of the reactor pipe 604 in proximity to where the waste stream enters the reactor pipe 604.

The pipe 902 may be a heat pipe although any suitable device may be employed. For example, the pipe 902 may be a hollow heat pipe with a heat pipe fluid disposed inside the heat pipe. The heat pipe fluid may include a working fluid such as reduced pressure water, acetone, solvents, ammonia, etc., although any suitable fluid may be employed. The pipe 902 may be similar to the material of the inner pipe 610 described above with reference to FIG. 6 although any suitable material may be employed. In FIG. 9, the pipe 902 is a cylinder, although any suitable shape may be employed.

In operation, a first region of the pipe 902 in the reactor heater 620 may increase to an abatement temperature (e.g., a temperature of the waste stream within the abatement bed 608, which may be, for example, a catalyst bed). Consequently, the heat pipe fluid may raise in temperature throughout the heat pipe 902. For example, a portion of the heat pipe fluid may become gaseous and rise to a second region in proximity to where an incoming waste stream enters the reactor pipe 604. Because the heat pipe fluid is at a temperature greater than the temperature of the incoming waste stream, the heat pipe may transfer heat to the waste stream. The temperature of the incoming waste stream may increase, and the heat pipe fluid may condense back to a liquid form and flow back to the first region. A similar heat exchanger (e.g., absent the catalyst bed), may be used for the heat exchanger 506 of oxidation system 406 of FIG. 5).

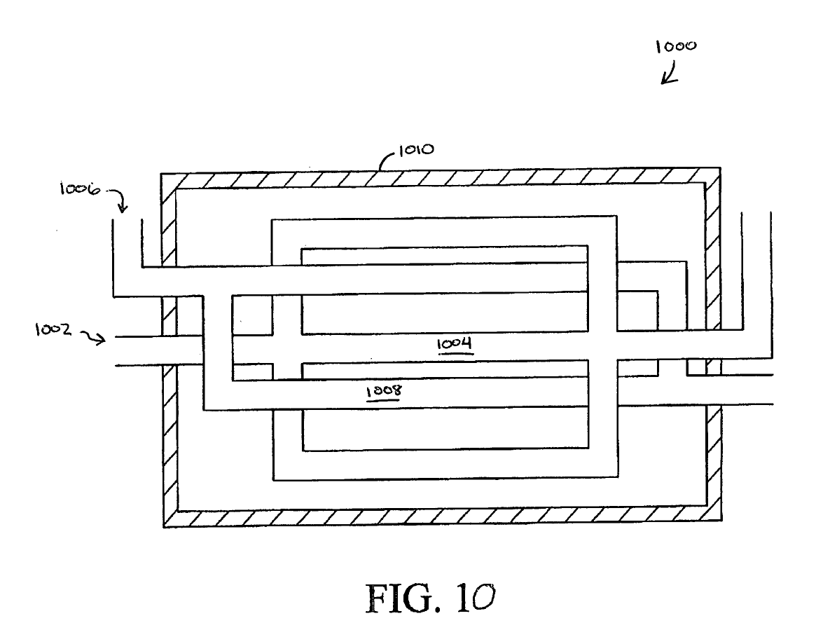

FIG. 10 is a schematic diagram of an exemplary cross heat exchanger 1000 that may be used for the heat exchanger 422 of the catalyst backpack 408 and/or for the heat exchanger 508 of the oxidation system 406 of FIGS. 4-5. Such a heat exchanger is similar to those described in previously incorporated U.S. Pat. No. 6,824,748.

With reference to FIG. 10, a gaseous waste stream to be abated (e.g., within the catalytic chamber 416 of FIGS. 4-5) enters the cross heat exchanger 1000 at a first inlet 1002, and is dispersed into a first set of multiple channels 1004. An abated gas stream (e.g., from the oxidation chamber 410 and/or the catalytic chamber 416) enters the heat exchanger at a second inlet 1006 and is dispersed into a second set of multiple channels 1008 which are adjacent and capable of transferring heat to the first multiple channels 1004 that carry the gaseous waste stream to be abated. Heat from the abated gas stream thereby is transferred to the gaseous waste stream to be abated. An insulating material 1010 may surround the heat exchanger 1000 to prevent the loss of heat to the atmosphere and to increase the efficiency of the heat exchanger 1000. The heat exchanger 1000 may be made of a corrosion resistant material such as a nickel-based alloy (e.g., Inconel®), or another suitable material.

The combination of oxidation, post oxidation scrubbing, catalysis and post catalysis scrubbing provides a total abatement solution for deposition processes such as chemical vapor deposition, etch processes, cleaning processes (e.g., NF3 cleaning) and numerous other semiconductor device manufacturing processes. For example, HAPs and VOCs may be removed by oxidation, and PFCs and any remaining HAPs and VOCs may be removed by catalysis. Acid and soluble byproducts may be removed by scrubbing. Up to 99% abatement efficiency of nearly all semiconductor-related gaseous byproducts including HAPs, VOCs and PFCs may be achieved.

As an example, in-situ CVD chamber cleaning processes typically generate high flows of CF4, C2F6, C3F8 and/or other gasses (e.g., up to 1.2 slm of C3F8 per chamber, 1.5 slm C2F6 per chamber and 2.0 slm CF4 per chamber). The abatement systems described herein may be used as a solution for PFC abatement for in-situ CVD chamber cleaning and/or similar processes. In at least one embodiment, the oxidation chamber 108 may be electrically heated, requiring no fuel. In such an embodiment, CVD PFC abatement may be performed with no fuel requirement and low risk. Further, the abatement system 100 or other abatement systems described herein may be created by retrofitting an existing oxidation chamber with a catalysis chamber/scrubber “backpack” as described previously with reference to FIGS. 2-5. Such a configuration has little or no impact on CVD performance or throughput, minimal risk for requalifying existing fabrication facilities and low cost when retrofitted to existing systems for PFC abatement.

Exemplary gasses and/or chemistries that may be effectively abated with the above-described abatement systems include B2H6, BC13, BF3, Br2, C2H4, CCl4, CH4, CHCl3, C12, CO, COF2, dichlorosilane (DCS), diethylamine (DEA), dimethylamine (DMA), ethanol, F2, GeH4, H2, HBr, HCl, HF, N2O, NH3, O3, octo-methyl-cyclic-tetra-siloxane (OMCTS), PH3, SiBr4, SiCl4, SiF4, SiH4, SO2, tetra-kis-dimethyl-amino-titanium (TDMAT), tri-ethyl-borate (TEB), tetra-ethyl-ortho-silicate (TEOS), tri-ethyl-phosphate (TEPO), TlCl4, trimethylsilane (TMS), WF6, C2F4, C2F6, C3F8, C4F6, C4F8, CF4, CHF3, NF3, SF6 and the like. Other gasses and/or chemistries also may be abated.

A significant improvement in halogen abatement also may be realized by combining oxidation and catalysis. For example, oxidation alone may sufficient for abating a single chamber. However, an oxidation chamber may suffer from reduced abatement efficiency if multiple chambers are abated. In such embodiments, the addition of a catalytic chamber (e.g., backpack) may greatly increase abatement capacity. In some embodiments, addition of a catalysis chamber may increase fluorine and chlorine abatement capacity by as much as double when compared to oxidation alone.

As another example, in some embodiments, the oxidation chamber 108, 410 is capable of abating about 2 liters/minute of a fluorine-containing waste stream with an abatement efficiency of at least 99%. Through addition of the catalyst chamber 416, an increased abatement capacity of about 4 liters/minute may be realized. That is, in some embodiments, the capacity of an abatement system that employs both oxidation and catalysis is approximately doubled when compared to the use of oxidation alone.

Likewise, use of an oxidation chamber with a catalytic chamber may significantly increase the performance and/or lifetime of the catalytic chamber. For example, any process that generates particles that may coat catalytic material within a catalytic chamber may degrade performance of the catalyst chamber (e.g., such as SiF4, a known catalyst poison). Use of oxidation before catalysis removes harmful gaseous waste stream products and/or by-products before the waste stream enters into a catalysis bed. Catalysis bed lifetime and efficiency thereby is improved as the catalytic material is not degraded by such contaminants. Further, catalysis bed lifetime and efficiency is improved as “pre-oxidation” reduces the quantity of gaseous waste to be abated (e.g., by effectively abating HAPs, VOCs, etc.). Table 1 below illustrates expected increases in abatement capacity by combining oxidation and catalysis.

TABLE 1

| | ABATEMENT CAPACITY | ABATEMENT CAPACITY |
|---|---|---|
| | CATALYSIS ONLY | OXIDATION AND |
| | (SCCM/LITER OF | CATALYSIS (SCCM/ |
| GAS | CATALYST) | LITER OF CATALYST) |
| CF4 | 63 | 126 |
| C3F8 | 50 | 100 |
| C4F8 | 55 | 110 |
| C2F6 | 58 | 116 |
| NF3 | >67 | >134 |
| CHF3 | >67 | >134 |
| SF6 | >67 | >134 |

Numerous gasses and/or chemistries may be effectively abated using either oxidation or catalysis. When such gasses and/or chemistries are abated within the combined oxidation and catalysis system of the present invention, a large improvement in overall abatement efficiency, capacity and lifetime of the abatement system is realized. Exemplary gasses and/or chemistries for which such benefits are realized include C2H4, CHCl3, CO, COF2, dimethylamine (DMA), GeH4, H2, NH3, O3, PH3, SiCl4, SiF4, and the like.

The foregoing description discloses only exemplary embodiments of the invention. Modifications of the above disclosed apparatus and methods which fall within the scope of the invention will be readily apparent to those of ordinary skill in the art. For instance, any number of scrubbers may be used after the oxidation chamber 108, 410 and/or after the catalyst chamber 112, 416 (e.g., 1, 2, 3, 4, etc.).

Other types and/or number of heat exchangers may be used. For example, concentric tube heat exchangers in which hot gas flows within an inner tube and cold gas flows within an outer tube (or vice versa) may be employed, as may gas-to-gas heat exchangers.

In some embodiments, the catalytic chamber 416 may be insulated and/or water-tight. The first scrubber after the catalytic chamber 416 may be a co-current scrubber, and the final scrubber after the catalytic chamber 416 may be a counter-current scrubber. Other configurations may be used. An additional water heat exchanger may be used within the catalytic backpack 408 (e.g., for cooling recirculated water from the scrubbers).

Accordingly, while the present invention has been disclosed in connection with exemplary embodiments thereof, it should be understood that other embodiments may fall within the spirit and scope of the invention, as defined by the following claims.

The invention claimed is:

1. An abatement apparatus comprising:
an oxidation unit adapted to receive an effluent stream from a semiconductor device manufacturing chamber;
a first water scrubber unit adapted to receive the effluent stream from the oxidation unit; and
a catalysis unit adapted to receive the effluent stream from the first water scrubber unit.

2. The abatement apparatus of claim 1 wherein oxidation unit is adapted to remove HAPs and VOCs from the effluent stream.

3. The abatement apparatus of claim 2 wherein the catalysis unit is adapted to remove PFCs from the effluent stream.

4. The abatement apparatus of claim 3 wherein the first water scrubber unit is adapted to remove acid byproducts from the effluent stream.

5. The abatement apparatus of claim 1 further comprising a second water scrubber unit adapted to receive the effluent stream from the catalysis unit.

6. The abatement apparatus of claim 1 wherein the abatement apparatus has an overall abatement capacity that is greater than an abatement capacity of the oxidation unit or catalysis unit alone.

7. The abatement apparatus of claim 1 wherein for a halogen-containing waste stream, the abatement apparatus has an overall abatement capacity that is greater than an abatement capacity of the oxidation unit.

8. The abatement apparatus of claim 7 wherein for a halogen-containing waste stream, the abatement apparatus has an overall abatement capacity that is at least double an abatement capacity of the oxidation unit.

9. The abatement apparatus of claim 1 wherein the abatement apparatus has an overall abatement capacity per unit volume of catalyst that is greater than an abatement capacity per unit volume of catalyst of the catalysis unit.

10. The abatement apparatus of claim 9 wherein the abatement apparatus has an overall abatement capacity per unit volume of catalyst that is at least double an abatement capacity per unit volume of catalyst of the catalysis unit.

11. The abatement apparatus of claim 1 further comprising a heat exchanger adapted to heat a waste stream before the waste stream enters the catalysis unit.

12. The abatement apparatus of claim 11 wherein the heat exchanger is adapted to heat the waste stream before the waste stream enters the catalysis unit using a heated waste stream from the oxidation unit.

13. The abatement apparatus of claim 11 wherein the heat exchanger is adapted to heat the waste stream before the waste stream enters the catalysis unit using a heated waste stream from the catalysis unit.

14. The abatement apparatus of claim 13 wherein the heat exchanger comprises a tube positioned within the catalysis unit so as to receive a waste stream after the waste stream passes through a catalyst within the catalysis unit.

15. The abatement apparatus of claim 15 wherein the catalysis unit is adapted to move relative to the oxidation unit so as to provided service access to at least the first water scrubber unit.

16. The abatement apparatus of claim 1 further comprising a pressure regulation device coupled to an output of the abatement apparatus and adapted to create a draft or negative pressure that draws a gaseous waste stream out of the abatement apparatus.

17. The abatement apparatus of claim 16 wherein the pressure regulation device is adapted to regulate exhaust moisture.

18. The abatement apparatus of claim 16 wherein the pressure regulation device is adapted to dilute the gaseous waste stream.

19. The abatement apparatus of claim 16 wherein the pressure regulation device is a blower.

20. The abatement apparatus of claim 16 wherein the pressure regulation device is an eductor.

21. The abatement apparatus of claim 1 wherein the oxidation unit is part of a first abatement system and the catalytic unit is part of a second abatement system that is retrofitted to the first abatement system.

22. An abatement apparatus comprising:
an oxidation unit adapted to receive an effluent stream from a semiconductor device manufacturing chamber and to abate the effluent stream;
a first water scrubber unit adapted to receive the effluent stream from the oxidation unit and to scrub the effluent stream;
a second water scrubber unit adapted to receive the effluent stream from the first water scrubber unit and to scrub the effluent stream;
a catalysis unit adapted to receive the effluent stream from the second water scrubber unit and to abate the effluent stream;
a third water scrubber unit adapted to receive the effluent stream from the catalysis unit and to scrub the effluent stream; and
a fourth water scrubber unit adapted to receive the effluent stream from the third water scrubber unit and to scrub the effluent stream.

23. The abatement apparatus of claim 22 further comprising a heat exchanger adapted to heat a waste stream before the waste stream enters the catalysis unit.

24. The abatement apparatus of claim 23 wherein the heat exchanger is adapted to heat the waste stream before the waste stream enters the catalysis unit using a heated waste stream from the oxidation unit.

25. The abatement apparatus of claim 23 wherein the heat exchanger is adapted to heat the waste stream before the waste stream enters the catalysis unit using a heated waste stream from the catalysis unit.

26. The abatement apparatus of claim 22 wherein the catalysis unit is adapted to move relative to the oxidation unit so as to provided service access to at least the first and second water scrubber units.

27. The abatement apparatus of claim 22 wherein the oxidation unit, first water scrubber unit and second water scrubber unit are part of a first abatement system and the catalytic unit, third water scrubber unit and fourth water scrubber unit are part of a second abatement system that is retrofitted to the first abatement system.

28. A method of abating a gaseous waste stream of a semiconductor device manufacturing system comprising:
receiving the gaseous waste stream;
abating the gaseous waste stream in an oxidation chamber;
scrubbing the gaseous waste stream after abating the gaseous waste stream in the oxidation chamber;
abating the gaseous waste stream in a catalyst chamber; and
scrubbing the gaseous waste stream after abating the gaseous waste stream in the catalyst chamber.

29. The method of claim 28 wherein scrubbing the gaseous waste stream after abating the gaseous waste stream in the oxidation chamber comprising passing the gaseous waste stream through at least two water scrubbers.

30. The method of claim 28 wherein scrubbing the gaseous waste stream after abating the gaseous waste stream in the catalyst chamber comprising passing the gaseous waste stream through at least two water scrubbers.

31. The method of claim 28 further comprising employing a heat exchanger to heat the gaseous waste stream before the gaseous waste stream enters the catalysis chamber.

32. The method of claim 31 wherein employing the heat exchanger to heat the gaseous waste stream comprises employing a heated waste stream from the oxidation chamber to heat the gaseous waste stream.

33. The method of claim 31 wherein employing the heat exchanger to heat the gaseous waste stream comprises using a heated waste stream from the catalysis chamber to heat the gaseous waste stream.

34. A method of forming an abatement system comprising:
providing a first abatement system having an oxidation chamber and at least one scrubber;
providing a second abatement system having a catalysis chamber and at least one scrubber; and
configuring the first and second abatement systems so as to form a single abatement unit in which a waste stream is abated within the first abatement system and then within the second abatement system.

35. The method of claim 34 further comprising configuring the first and second abatement systems so as to provide service access to both the first and second abatement systems.
